(19) United States
(12) Patent Application Publication
(10) Pub. No.: US 2005/0080631 A1
(43) Pub. Date: Apr. 14, 2005

(54) Information processing apparatus and method therefor

(76) Inventors: Kazuhiko Abe, Yokohama-shi (JP); Akinori Kawamura, Kunitachi-shi (JP); Yasuyuki Masai, Yokohama-shi (JP); Makoto Yajima, Tachikawa-shi (JP); Kohei Momosaki, Kawasaki-shi (JP); Munehiko Sasajima, Yokohama-shi (JP); Koichi Yamamoto, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/917,344

(22) Filed: Aug. 13, 2004

(30) Foreign Application Priority Data
Aug. 15, 2003 (JP) 2003-207622

(51) Int. Cl. G10L 11/00

(52) U.S. Cl. 704/276

(57) ABSTRACT

An information processing apparatus using a speech signal, comprising a playback unit configured to play back the speech signal, a speech recognition unit configured to subject the speech signal to speech recognition, a text generator to generate a linguistic text having linguistic elements and time information for synchronizing with playback of the speech signal, by using a speech recognition result of the speech recognition unit, and a presentation unit configured to present selectively the linguistic elements together with the time information in synchronism with the speech signal played back by the playback unit.

### CROSS-REFERENCE TO RELATED APPLICATIONS

This application is based upon and claims the benefit of priority from prior Japanese Patent Application No. 2003-207622, filed Aug. 15, 2003, the entire contents of which are incorporated herein by reference.

### BACKGROUND OF THE INVENTION

1. Field of the Invention

The present invention relates to an information processing apparatus, particularly to an information processing apparatus to output linguistic information based on a speech recognition result and a information processing method therefor.

2. Description of the Related Art

Recently, research is done flourishingly on meta data generation using linguistic information obtained by a speech recognition result of a speech signal. It is useful for data management or search to apply generated meta data to a speech signal.

For example, Japanese Patent Laid-Open

No. 8-249343 provides a technique to realize a search of desired audio data by extracting a specific expression and keyword from a linguistic text obtained by a speech recognition result of audio data, and indexing it to build an audio data base.

There is a technique that the linguistic text obtained by a speech recognition result is used as meta data used for a data management or a search. However, there is not a technique of displaying in dynamic the linguistic text of the speech recognition result so that a user can easily understand contents of a speech and that of a video corresponding to the speech and perform a playback control.

The object of the present invention is to provide an information processing apparatus capable of generating a linguistic text by speech recognition and displaying the linguistic text in dynamic, and a method therefor.

### BRIEF SUMMARY OF THE INVENTION

An aspect of the present invention is to provide an information processing apparatus using a speech signal, comprising: a playback unit configured to play back the speech signal; a speech recognition unit configured to subject the speech signal to speech recognition; a text generator to generate a linguistic text having linguistic elements and time information for synchronizing with playback of the speech signal, by using a speech recognition result of the speech recognition unit; and a presentation unit configured to present selectively the linguistic elements together with the time information in synchronism with the speech signal played back by the playback unit.

Another aspect of the present invention is to provide an information processing apparatus using a video-audio signal, comprising: a speech playback unit configured to play back a speech signal from the video-audio signal; a speech recognition unit configured to subject the speech signal to speech recognition; a text generator to generate a linguistic text having linguistic elements and time information for synchronizing with playback of the speech signal, by using a speech recognition result of the speech recognition unit; a presentation unit configured to present selectively the linguistic elements together with the time information in synchronism with the speech signal played back by the speech playback unit.

Another aspect of the present invention is to provide an information processing method comprising: subjecting a speech signal to speech recognition to obtain a speech recognition result; generating a linguistic text including linguistic elements and time information for synchronizing with playback of the speech signal according to the speech recognition result; playing back the speech signal; and displaying selectively the linguistic elements together with the time information in synchronism with the playback speech signal.

### BRIEF DESCRIPTION OF THE SEVERAL VIEWS OF THE DRAWING

FIG. 1 is a block diagram illustrating a schematic configuration of a television receiver related to the first embodiment of the present invention.

FIG. 2 shows a flowchart showing in detail a procedure of a process carried out by a linguistic information output unit.

FIG. 3 shows an example of a linguistic information output based on a speech recognition result.

FIG. 4 shows a flowchart of an example of a procedure for setting a presentation method.

FIG. 5 is a diagram illustrating an example of keyword caption display.

FIG. 6 is a block diagram of a schematic configuration of a home server related to the second embodiment of the present invention.

FIG. 7 is a diagram illustrating an example of a search screen provided by a home server.

FIG. 8 is a diagram illustrating a state of contents selection based on keyword scrolling display.

### DETAILED DESCRIPTION OF THE INVENTION

There will now be described an embodiment of the present invention in conjunction with the accompanying drawings.

(First Embodiment)

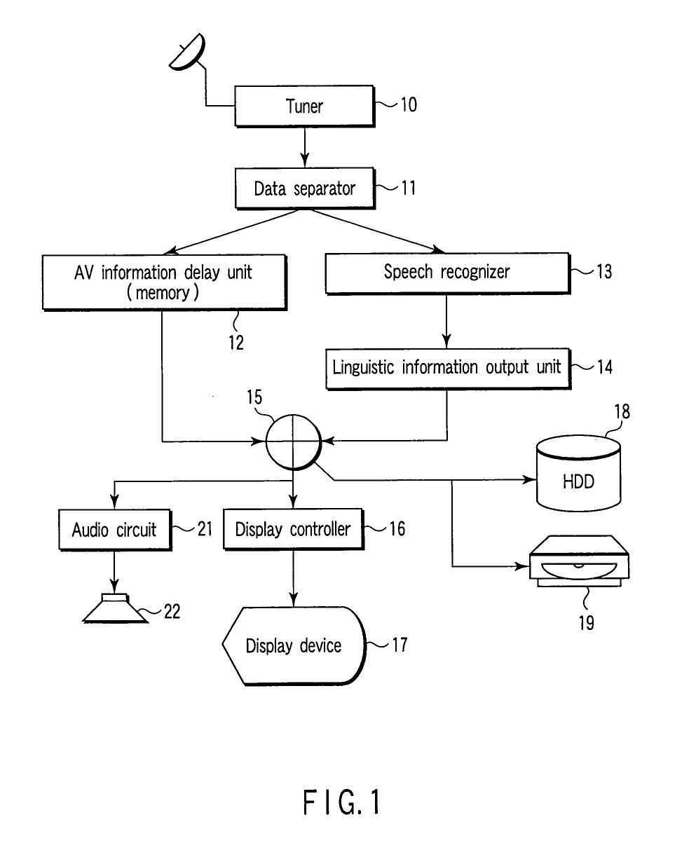

FIG. 1 is a block diagram illustrating a schematic configuration of a television receiver related to the first embodiment of the present invention. This television receiver comprises a tuner 10 connected to a radio antenna to receive a broadcasted video-audio signal, and a data separator 11 to output a video-audio signal (AV (Audio Visual) information) received with the tuner 10 to an AV information delay unit 12. Also, the data separator separates a speech signal from the video-audio signal to output it to a speech recognition unit 13. The television receiver includes a speech recognizer 13 to subject an speech signal output from the data separator 11 to speech recognition, and a linguistic information output unit 14 to generate linguistic information having a linguistic text including linguistic elements such as words, based on a speech recognition result of the speech recognition unit 13 and time information for synchronizing with playback of the speech signal.

The AV information delay unit (memory) 12 temporarily stores AV information output from the data separator 10. This AV information is delayed till the AV information is speech-recognized with the speech recognition unit 13. Linguistic information is generated based on the speech recognition result. The AV information is output from the AV information delay unit 12 when the generated linguistic information is output from the linguistic information output unit 14. The speech recognition unit 13 acquires information including part-of-speech information of all recognizable words as linguistic information from the speech signal.

The delayed AV information output from the AV information delay unit 12 and the linguistic information output from the linguistic information output unit 14 are supplied to the synchronous processor 15. The synchronous processor 15 plays back the delayed AV information. In addition, the synchronous processor 15 converts the linguistic text included in the linguistic information to a video signal, and outputs it to the display controller 16 in synchronism with playback of the AV information. The speech signal of the AV information played back by the synchronous processor 15 is input to a speaker 22 via an audio circuit 21, and the video playback signal is supplied to the display controller 16.

The display controller 16 synthesizes the video signal of the linguistic text with the image signal of the AV information and supplies it to the display 17 to display it. The linguistic information output from the linguistic information output unit 14 can be stored in a recorder 18 such as HDD or a recording medium such as a DVD 19.

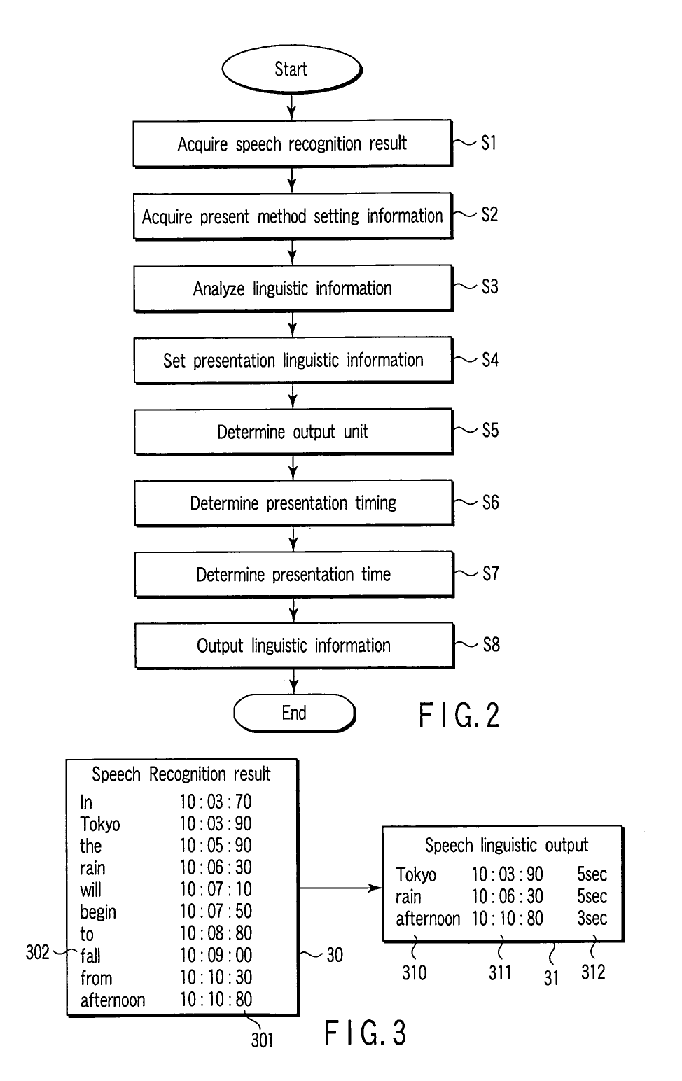

FIG. 2 shows a flowchart representing in detail a procedure of a process carried out by the linguistic information output unit 14.

At first, in step S1, the linguistic information output unit 14 acquires a speech recognition result from the speech recognizer 13. A presentation method of the linguistic information is set along with speech recognition or beforehand (step S2). The acquisition of information for setting the presentation method is described hereinafter.

In step S3, the linguistic text included in the speech recognition result acquired by the speech recognizer 13 is analyzed. This analysis can use a well known morphological analysis technique. Various kinds of natural language processing such as extraction of a keyword and an important sentence from the analysis result of the linguistic text are performed. For example, summary information may be generated based on the morphological analysis result of the linguistic text included in the speech recognition result, and used as linguistic information of an object to be presented. It should be noted that time information for synchronizing with playback of the speech signal is necessary for the linguistic information based on such summary information.

In step S4, presentation linguistic information is selected. Concretely, information on words and phrases or information on sentences is selected according to setting information such as basis of selection, quantity of presentation. In step S5, an output (presentation) unit of the presentation linguistic information selected in step S4 is determined. In step S6, the presentation timing is set every output unit based on the speech start time information. In step S7, the time length of presentation continuation is determined for each output unit.

In step S8, linguistic information representing a presentation notation, a presentation start time, and a length of presentation continuous time is output. FIG. 3 is a diagram of an example of linguistic information based on a speech recognition result. The speech recognition result 30 includes at least a character string 300 representing a linguistic component of the linguistic text and a speech start time 301 of a speech signal corresponding to the character string 300. This speech start time 301 corresponds to time information referred to in displaying the linguistic information in synchronism with playback of the speech signal. The linguistic information output 31 represents a result obtained by a process executed by the linguistic information output unit 14 according to the set presentation method. This linguistic information output 31 comprises a presentation notation 310, a presentation start time 311 and a presentation continuous time length (second) 312. As understood from FIG. 3, the presentation notation 310 is a linguistic element chosen as a keyword, for example, a noun. The other words are excluded from the presentation notation 310. For example, the presentation notation “TOKYO” starts to be displayed from a presentation start time “10:03:08” during the continuous time of “five seconds”. Such linguistic information output 31 can be output along with an image as so-called caption or linguistic information synchronizing with only a speech.

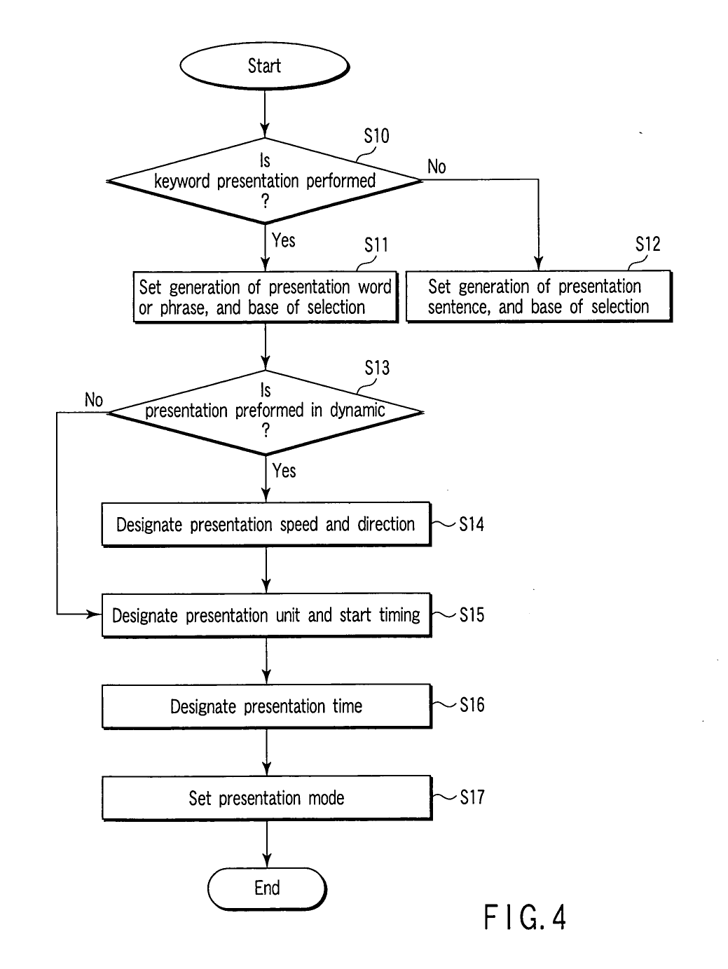

FIG. 4 shows a flowchart representing an example of a procedure for setting the presentation method. For example, the procedure for setting the presentation method is performed via DIALOG screens and so on, using, for example, a GUI (graphical user interface) technique.

At first, in step S10, it is decided whether to present the keyword (important word or phrase). When the keyword is presented, the process advances to step S11. Otherwise, the process advances to step S12. When the keyword is presented, linguistic information is chosen and presented in units of a sentence.

In step S11 for setting generation of presentation word or phrase, and base of selection, a user sets part-of-speech specification, the important word or phrase presentation, the priority presentation word or phrase, presentation quantity. In step S12 for setting the presentation sentence generation and base of selection, the user sets representation of a sentence including designated words or phrases, a summary ratio and so on. When setting is done by either of step S11 or step S12, the process advances to step S13. In step S13, it is decided whether the linguistic information should be presented in dynamic. When the user instructs a dynamic presentation, a velocity and direction of the dynamic presentation are set in step S14. Concretely, the scrolling direction and speed at that the represent notation is scrolled are set.

In step S15, a unit of presentation and a start timing are designated. The unit of presentation is “sentence”, “clause”, or “words and phrases”, a sentence head speech start time, a clause speech start time, a word-and-phrase speech start time are set to a start timing. In step S16, a presentation continuous time is designated in units of a presentation. In here, on the presentation continuous time, “until the speech start of the next word or phrase”, “the number of seconds”, or “until the end of a sentence” can be designated. In step S17, a presentation mode is set. The presentation mode includes, for example, position of a unit of presentation, character stile (font), size, and so on. The presentation mode is preferably set for all words and phrases or every designated word or phrase.

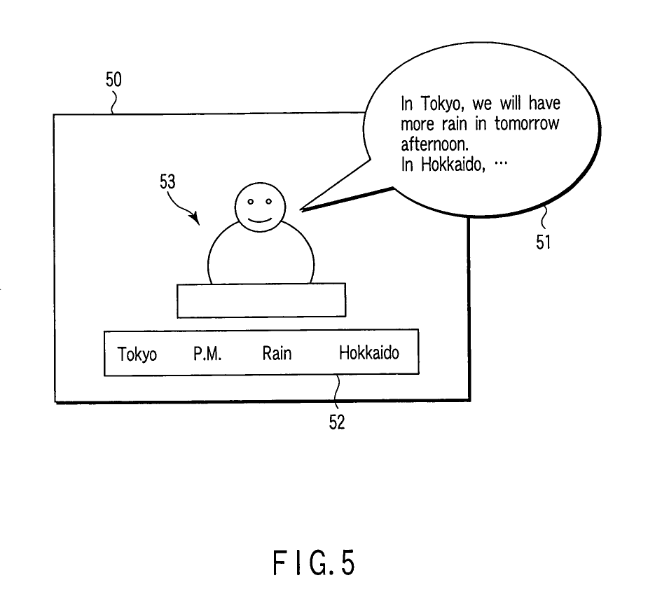

FIG. 5 shows an example of keyword caption display. The display screen 50 shown in FIG. 5 is displayed on the display 17 of the television receiver of the present embodiment. On this display screen 50 is displayed an image 53 based on AV information of the broadcast signal received. The balloon 51 represents contents of a speech synchronizing with the image 53. This speech contents 51 are output by a speaker. The keyword caption 52 displayed in the display screen 50 along with the image 53 corresponds to a keyword extracted from the speech contents 51. This keyword scrolls in synchronism with the speech contents from the speaker.

A TV viewer can visually understand the speech contents 51 in synchronism with the image 53 according to the dynamic display (presentation) of such keyword caption. The playback output speech contents 51 helps understanding of the contents such as confirmation of miss heard contents or prompt understanding of broad contents. The speech recognizer 13, the linguistic information output part 14, the synchronous processor 15, the display controller 16 and so on may be executed by computer software.

(Second Embodiment)

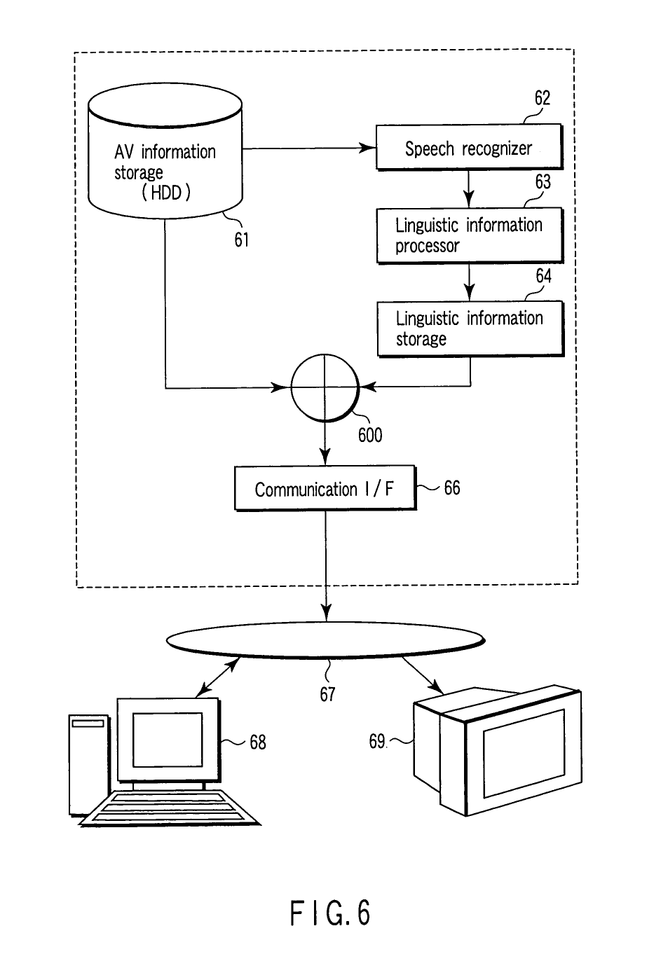

FIG. 6 is a block diagram illustrating a schematic configuration of a home server related to the second embodiment of the present invention. As shown in FIG. 6, a home server 60 of the present embodiment includes an AV information storage unit 61 storing AV information, and a speech recognizer 62 to subject a plurality of speech signals included in AV information stored in the AV information storage unit 61 to speech recognition. The home server 60 also includes a linguistic information processor 63 connected to the speech recognizer 62 to generate a linguistic text based on a speech recognition result of the speech recognizer 62 and carry out linguistic processing for extracting a keyword. The output port of the linguistic information processor 63 is connected to a linguistic information memory 64 to store a language processing result of the linguistic information processor 63. In linguistic processing of the linguistic information processor 63, part of the presentation method setting information that is described in the first embodiment is used.

The home server 60 includes further a search processor 600 providing a search screen for searching for AV information stored in the AV information storage unit 61 to a user terminal 68 and a network electrical household appliances and electrical equipment (AV television) 69 through a network 67 from a communication I/F (interface) unit 66.

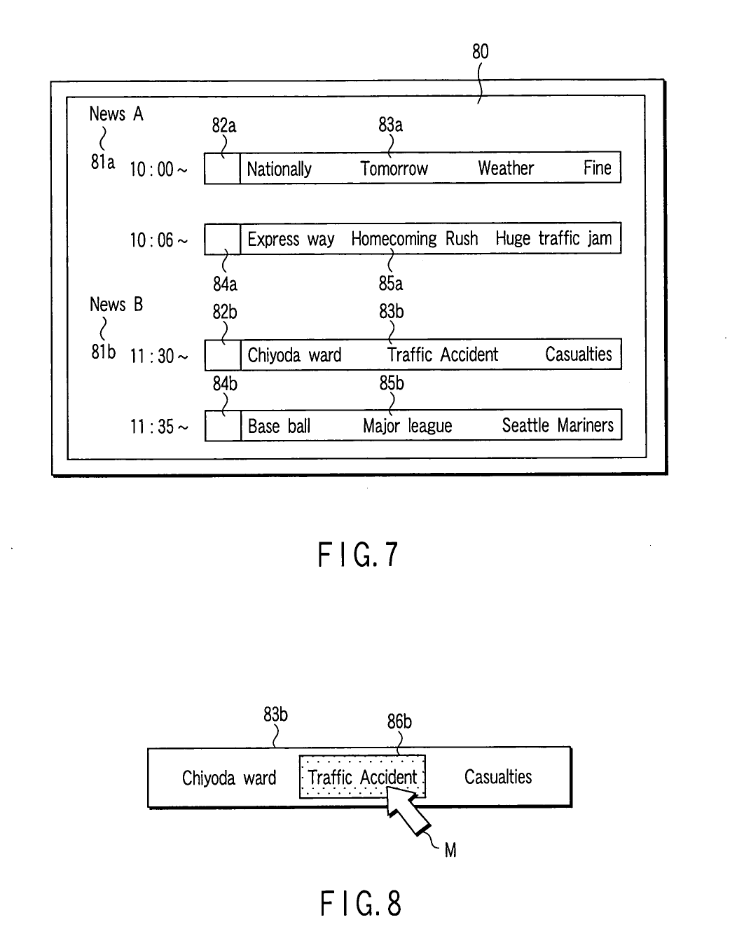

FIG. 7 is a diagram showing an example of a search screen provided by the home server. The search screen 80 provided by the search processor 600 is displayed on the user terminal 68 or the network electrical household appliances and electrical equipment (AV television) 69. Indications 81a and 81b in this search screen 80 correspond to AV information stored in the AV information storage unit 61 (referred to as “contents”). The representative image (reduced still image) of the part contents obtained by dividing the description of the contents 81a (here, “news A”) or the reduced video of part contents is displayed on the region 82a. The linguistic information representing the speech contents of the part contents to assume 10:00 to be a start time is displayed in scroll on the region 83a. In other words, the linguistic information is provided from the linguistic information processor 63, and corresponds to a keyword extracted from the linguistic text obtained by a speech recognition result. Similarly, the linguistic information representing a speech description of the part contents to assume 10:06 to be a start time is displayed in scroll on the region 85a.

The representative image (reduced still image) of the part contents obtained by dividing the contents 81b (here, “news B”) or the reduced video of part contents is displayed on the region 82b. The linguistic information representing the speech contents of the part contents to assume 11:30 to be a start time is displayed in scroll on the region 83b. The linguistic information representing the speech contents of the part contents to assume 11:35 to be a start time is displayed in scroll on the region 83b.

The keywords of the speech contents of the part contents are displayed every part contents in a list on the search screen 80 provided by the search processor 600 as above. If the speech contents attains at its end in each scrolling display, it comes back to its beginning again, and repeats its display. In the case of displaying the regions 82a, 84a, 82b and 84b by movie display, the movie display and the scrolling display may be synchronized in the contents. In this case, the first embodiment may be taken into account. When a linguistic text is subjected to speech recognition, time information for synchronization may be derived from (the speech signal of) the contents to be recognized.

When a user specifies a keyword 86b by, for example, a mouse M in the search screen 80 as shown in FIG. 8, for example, corresponding contents are selected. In this particular example, part contents to assume 11:30 to be a start time in the contents 81b of “News B” are selected. The part contents are read from the AV information memory 61, and the communication I/F unit 66 transmits the part contents to the user terminal 68 (or the AV television 69) through the network 67. In this case, in the part contents of “News B”, it is desirable to start to be played back from a position corresponding to the keyword “traffic accident” 86b specified by the user. The home server 60 may make contents data after the keyword “traffic accident” 86b, and transmit it.

According to the second embodiment, a TV viewer can understand visually the speech content of the contents by the dynamic scrolling display of the keyword generated based on the speech recognition result. In addition, desired contents can be adequately selected from the contents listed based on visual understanding of the speech content, resulting in realizing efficient search of the AV information. According to the current invention as discussed above, it is possible to provide an information processing apparatus to generate a linguistic text by speech recognition, and display the linguistic text in a dynamic, and a method therefor.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An information processing apparatus using a speech signal, comprising:
a playback unit configured to play back the speech signal;
a speech recognition unit configured to subject the speech signal to speech recognition;
a text generator to generate a linguistic text having linguistic elements and time information for synchronizing with playback of the speech signal, by using a speech recognition result of the speech recognition unit; and
a presentation unit configured to present selectively the linguistic elements together with the time information in synchronism with the speech signal played back by the playback unit.

2. An information processing apparatus using a video-audio signal, comprising:
a speech playback unit configured to play back a speech signal from the video-audio signal;
a speech recognition unit configured to subject the speech signal to speech recognition;
a text generator to generate a linguistic text having linguistic elements and time information for synchronizing with playback of the speech signal, by using a speech recognition result of the speech recognition unit; and
a presentation unit configured to present selectively the linguistic elements together with the time information in synchronism with the speech signal played back by the speech playback unit.

3. The apparatus according to claim 2, which further includes a receiver unit configured to receive the video-audio signal including the speech signal, and a delay unit configured to store temporarily the video-audio signal received by the receiver unit and delayed output of the video-audio signal till the text generator generates the linguistic text.

4. The apparatus according to claim 2, which includes a video player to play back a video signal of the video-audio signal in synchronism with the speech signal, and wherein the presentation unit includes a display device configured to display the linguistic text together with the video signal played back by the video player.

5. The apparatus according to claim 4, which further includes a receiver unit configured to receive the video-audio signal including the speech signal, and a delay unit configured to store temporarily the video-audio signal received by the receiver unit and delayed output of the video-audio signal till the text generator generates the linguistic text.

6. The apparatus according to claim 2 and adopted to a recording medium, which further includes a synthesis unit configured to synthesize an image signal representing the linguistic text with the playback video signal, and an output unit configured to output a synthesis result of the synthesis unit to the recording medium.

7. The apparatus according to claim 6, which further includes a receiver unit configured to receive the video-audio signal including the speech signal, and a delay unit configured to store temporarily the video-audio signal received by the receiver unit and delayed output of the video-audio signal till the text generator generates the linguistic text.

8. The apparatus according to claim 2, wherein the linguistic elements includes words.

9. An information processing apparatus comprising:
a memory to store a plurality of speech signals,
a text generator to generate a plurality of linguistic texts by subjecting the speech signal to speech recognition;
a keyword extractor to extract a plurality of keywords from the linguistic texts; and
a display device configured to display the keywords in dynamic.

10. The apparatus according to claim 9, wherein the display is configured to display a plurality of keywords in dynamic for each of the linguistic texts.

11. The apparatus according to claim 9, which includes a selector to select from the speech signals of the memory a speech signal corresponding to a keyword of the keywords which is specified by a user, and a speech reproducer to reproduce the speech signal selected by the selector.

12. The apparatus according to claim 11, wherein the display is configured to display a plurality of keywords in dynamic for each of the linguistic texts.

13. The apparatus according to claim 11 and adopted to a user terminal, which includes a transmitter to transmit the speech signal or the video-audio signal to the user terminal via a network.

14. The apparatus according to claim 9, wherein the memory stores video-audio signals including the speech signal, and which includes a selector to select from the video-audio signals of the memory a video-audio signal corresponding to a keyword of the keywords which is specified by a user, and a video-audio reproducer to reproduce the video-audio signal selected by the selector.

15. The apparatus according to claim 14, wherein the display is configured to display a plurality of keywords in dynamic for each of the linguistic texts.

16. The apparatus according to claim 14 and adopted to a user terminal, which includes a transmitter to transmit the speech signal or the video-audio signal to the user terminal via a network.

17. The apparatus according to claim 9, wherein the keywords each represent part of speech contents of the speech signal.

18. An information processing method comprising:
subjecting a speech signal to speech recognition to obtain a speech recognition result;
generating a linguistic text including linguistic elements and time information for synchronizing with playback of the speech signal according to the speech recognition result;
playing back the speech signal; and
displaying selectively the linguistic elements together with the time information in synchronism with the playback speech signal.

19. An information processing method comprising:
storing a plurality of speech signals, subjecting the speech signals to speech recognition to generate a plurality of linguistic texts;
extracting a plurality of keywords from the linguistic texts; and
displaying the keywords in dynamic.

20. An information processing program stored in a computer readable medium, comprising:
means for instructing a computer to subject a speech signal to speech recognition to obtain a speech recognition result;
means for instructing the computer to generate a linguistic text including time information for synchronizing with playback of the speech signal according to the speech recognition result;
means for instructing the computer to reproduce the speech signal; and
means for instructing the computer to display the linguistic text in synchronism with the reproduced speech signal.

21. An information processing program stored in a computer readable medium, comprising:
means for instructing a computer to store a plurality of speech signals in a memory,
means for instructing the computer to subject the speech signals to speech recognition to generate a plurality of linguistic texts;
means for instructing the computer to extract a plurality of keywords from the linguistic texts; and
means for instructing the computer to display the keywords in dynamic.
